(19) United States
(12) Patent Application Publication
(10) Pub. No.: US 2020/0167689 A1
(43) Pub. Date: May 28, 2020

(54) METHOD, APPARATUS, AND SYSTEM FOR PROVIDING DATA-DRIVEN SELECTION OF MACHINE LEARNING TRAINING OBSERVATIONS

(71) Applicant: HERE GLOBAL B.V., Eindhoven (NL)

(72) Inventors: Nicholas POJMAN, San Francisco, CA (US); Anish MITTAL, San Francisco, CA (US); Zhanwei CHEN, Richmond, CA (US)

(21) Appl. No.: 16/203,087

(22) Filed: Nov. 28, 2018

(51) Int. Cl. G06N 20/00; G06K 9/62; G06F 3/0484

(52) U.S. Cl. CPC G06N 20/00; G06F 3/04842; G06K 9/6256

(57) ABSTRACT

An approach is provided for selecting machine learning training observations. The approach, for example, involves providing data for presenting a user interface displaying a plurality of training images and specifying a feature to label in the plurality of training images. The feature is selected based on an image selection criterion. The approach also involves receiving a set of feature labels for the plurality of training images via the user interface based on crowd-sourced input data. The approach further involves training a machine learning based image selector to select a plurality of images, a plurality of patches of a larger image, or a combination thereof for labeling based on the set of feature labels and the plurality of training images.

### BACKGROUND

Over the past decades, massive increases in the scale and type of annotated data have accelerated advances in all areas of machine learning. This has enabled major advances is many areas of science and technology, as complex models of physical phenomena or user behavior, with millions or perhaps billions of parameters, can be fit to data sets of increasing size. The process of getting quality annotations is often the most time-consuming and expensive part of the machine learning pipeline, as it requires human input for each observation, which can number in the hundreds of thousands to millions. Selecting a diverse set of observations (e.g., images)—to obtain annotations on—that span different kinds of conditions related to weather, traffic, vegetation, business, exposure, etc. is challenging. Diversity is needed to ensure generalizability of the machine learning detectors. Accordingly, service providers face significant technical challenges to enable efficient automated means for determining which observations are to be annotated and included in training data sets for machine learning to achieve diversity.

### SOME EXAMPLE EMBODIMENTS

Therefore, there is a need for a data-driven approach for automated image selection to create a diverse set of machine learning training observations (e.g., images) to train a machine learning feature detector.

According to one embodiment, a computer-implemented method comprises providing data for presenting a user interface displaying a plurality of training images and specifying a feature to label in the plurality of training images. The feature, for instance, is selected based on an image selection criterion (e.g., rarity of the feature in a pool of images). The method also comprises receiving a set of feature labels for the plurality of training images via the user interface based on crowd-sourced input data (e.g., non-expert labeling). The method further comprises training a machine learning based image selector to select a plurality of images, a plurality of patches of a larger image, or a combination thereof for labeling based on the set of feature labels and the plurality of training images (e.g., expert labeling).

According to another embodiment, an apparatus comprises at least one processor, and at least one memory including computer program code for one or more computer programs, the at least one memory and the computer program code configured to, with the at least one processor, cause, at least in part, the apparatus to provide data for presenting a user interface displaying a plurality of training images and specifying a feature to label in the plurality of training images. The feature, for instance, is selected based on an image selection criterion (e.g., rarity of the feature in a pool of images). The apparatus is also caused to receive a set of feature labels for the plurality of training images via the user interface based on crowd-sourced input data (e.g., non-expert labeling). The apparatus is further caused to train a machine learning based image selector to select a plurality of images, a plurality of patches of a larger image, or a combination thereof for labeling based on the set of feature labels and the plurality of training images (e.g., expert labeling).

According to another embodiment, a non-transitory computer-readable storage medium carries one or more sequences of one or more instructions which, when executed by one or more processors, cause, at least in part, an apparatus to provide data for presenting a user interface displaying a plurality of training images and specifying a feature to label in the plurality of training images. The feature, for instance, is selected based on an image selection criterion (e.g., rarity of the feature in a pool of images). The apparatus is also caused to receive a set of feature labels for the plurality of training images via the user interface based on crowd-sourced input data (e.g., non-expert labeling). The apparatus is further caused to train a machine learning based image selector to select a plurality of images, a plurality of patches of a larger image, or a combination thereof for labeling based on the set of feature labels and the plurality of training images (e.g., expert labeling).

According to another embodiment, an apparatus comprises means for providing data for presenting a user interface displaying a plurality of training images and specifying a feature to label in the plurality of training images. The feature, for instance, is selected based on an image selection criterion (e.g., rarity of the feature in a pool of images). The apparatus also comprises means for receiving a set of feature labels for the plurality of training images via the user interface based on crowd-sourced input data (e.g., non-expert labeling). The apparatus further comprises means for training a machine learning based image selector to select a plurality of images, a plurality of patches of a larger image, or a combination thereof for labeling based on the set of feature labels and the plurality of training images (e.g., expert labeling).

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing data-driven selection of machine learning training observations, according to one embodiment;

FIG. 2 is a diagram of components of a mapping platform capable of providing data-driven selection of machine learning training observations, according to one embodiment;

FIG. 3 is a flowchart of a process for providing data-driven selection of machine learning training observations, according to one embodiment;

FIG. 4 is a diagram of a user interface for providing data-driven selection of machine learning training observations, according to one embodiment;

FIG. 5 is a diagram illustrating an example process flow for providing data-driven selection of machine learning training observations, according to one embodiment;

FIG. 6 is a diagram of a geographic database, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing data-driven selection of machine learning training observations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

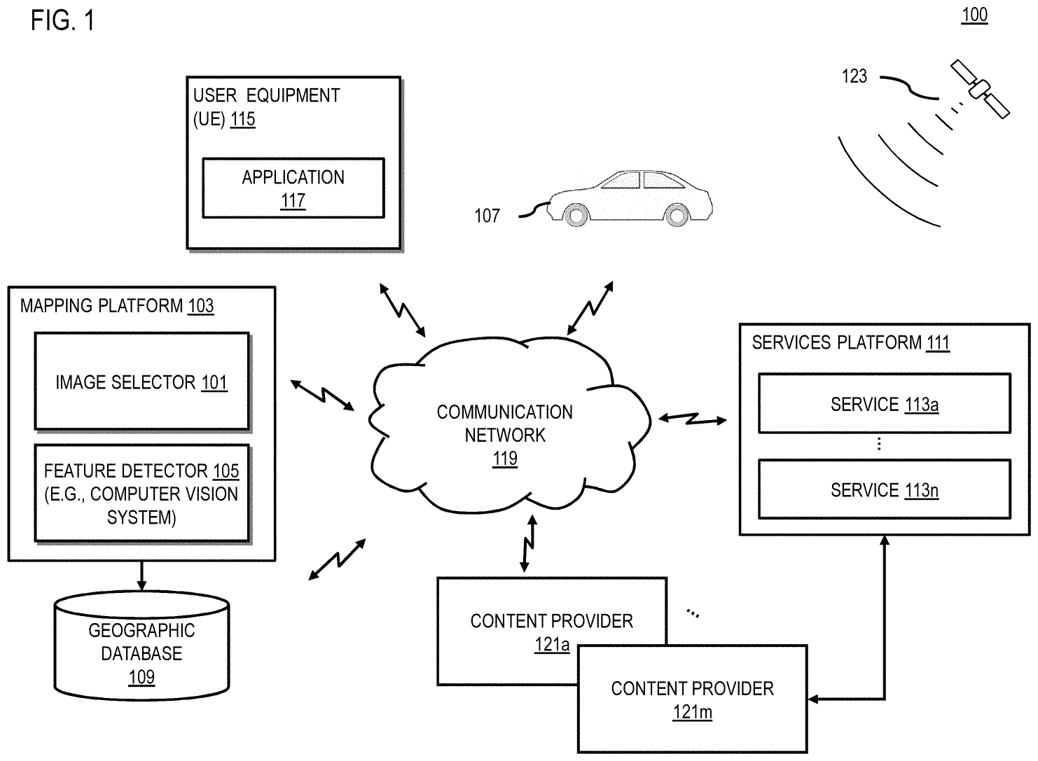

FIG. 1 is a diagram of a system capable of providing data-driven selection of machine learning training observations, according to one embodiment. As noted above, training a machine learning model generally requires a large set of annotated observations. In one embodiment, annotated observations can be data records or files representing or recording observations of a phenomenon that have been manually labeled with features or characteristics identified by an observer. For example, with training a machine learning model to detect objects or features depicted in images, an annotated observation can be an image that has been labeled with the objects or features as identified by a human labeler as being depicted in the corresponding image. However, obtaining a large set of such high quality observations is very expensive and consumes considerable resources. As a result, service providers often have many more unlabeled observations (e.g., images) than labeled observations that could otherwise be used for training machine learning models/feature detectors.

For example, a mapping service provider may have at its disposal datastores containing millions of street-level vehicle capture images, and satellite imagery which the mapping service provider would like to have annotated with a set of pre-defined features (e.g., including ground control points, lane markings, road signs, and poles, among others). Time and financial constraints make it impossible or prohibitive for the mapping service provider to have the entire pool of available images annotated/reviewed by a human contributor. Machine learning models generally exhibit increased accuracy and robustness when they are trained on diverse sets of observations. However, many of the images contained in our datastore are redundant, since, for example, several consecutive images captured along a stretch of highway will contain the same lane markings and road signs and will have been captured in similar lighting and weather conditions. Thus, a major technical challenge that mapping service providers face is identifying a diverse, representative sample of images from a large pool of available data.

In other words, a large number of labeled observations is often not sufficient to train an effective machine learning model. Just as important is the diversity of observations seen by the model during its training phase. A model which has only seen or been trained using many examples of the same type of observation will have a difficult time generalizing to different types of observations, while a model which has seen or been trained on several examples of many types of observation will generalize better. Moreover, labeling or annotating a large number of observations of the same type can lead to inefficient use of resources that can be more effectively used to label or annotate a wider range of observations of different types to improve the model generalization. Therefore, expending labeling effort on randomly chosen images (as is traditionally done) is an inefficient use of high quality trained domain expert humans (e.g., humans labelers with expertise in feature labeling). The problems and challenges get compounded when the mapping service provider needs to get annotations for rare features, like, traffic lights, left arrows, diamond signs etc.

To address these problems, the system 100 of FIG. 1 introduces a capability to train a machine learning-based image selector 101 (e.g., of a mapping platform 103) to automatically select a set of diverse content or observations (e.g., images) for human annotation to generate a training data set for other machine learning models (e.g., a feature detector 105 such as a computer vision system). In one embodiment, the system 100 can use crowd-sourced users who are not necessarily experts at the feature labeling task (e.g., have no domain specific knowledge or training), but could be used to provide labeling of images to use as an initial training data set to guide better selection of content for annotation. In this way, the system 100 advantageously provides for more efficient use of labeling resources (e.g., expert human labelers with domain specific knowledge or training in feature labeling) by prioritizing the annotation of the images that are selected by the trained image selector 101. The image selector 101, for instance, is trained to select images that provide maximal benefit (e.g., exhibit image diversity) to machine learning models such as the feature detector 105 that will be trained using the annotated images.

In other words, the system 100 uses a crowd driven approach for selecting images for annotation that is empirical and data driven (e.g., depending of crowd-sourced labeling data for initial image selecting training) as opposed to traditional random sampling approaches for determining which images to label. Since machine learning models (e.g., the image selector 101) are trained to make image selections, the system 100 advantageously avoids the need to hand craft the features needed for the selection process.

In one embodiment, the system 100 then provides the images automatically selected by the image selector 101 to expert human labelers to annotate and create a more robust and general training data set. The training data set can then be used to train other machine learning models (e.g., the feature detector 105) for any number of machine learning applications. For example, the training data set can used to train the feature detector 105 for any number of computer vision applications including but not limited to autonomous driving (e.g., with respect to a vehicle 107), vehicle localization, digital map making (e.g., with respect to a geographic database 109), and/or the like.

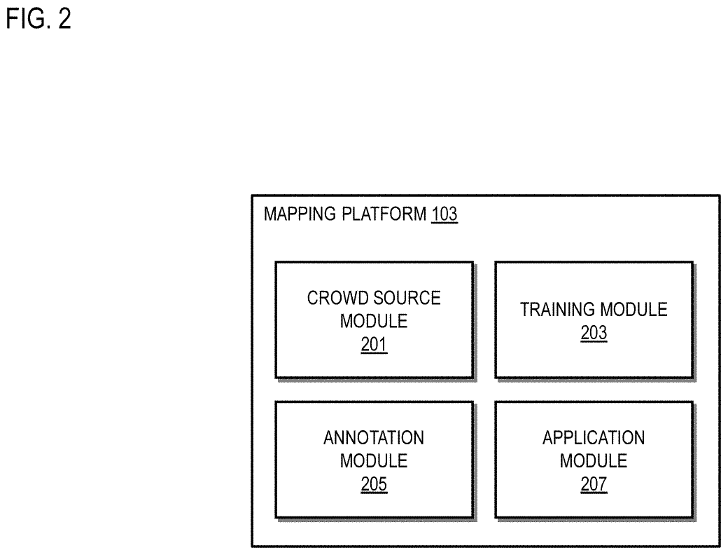

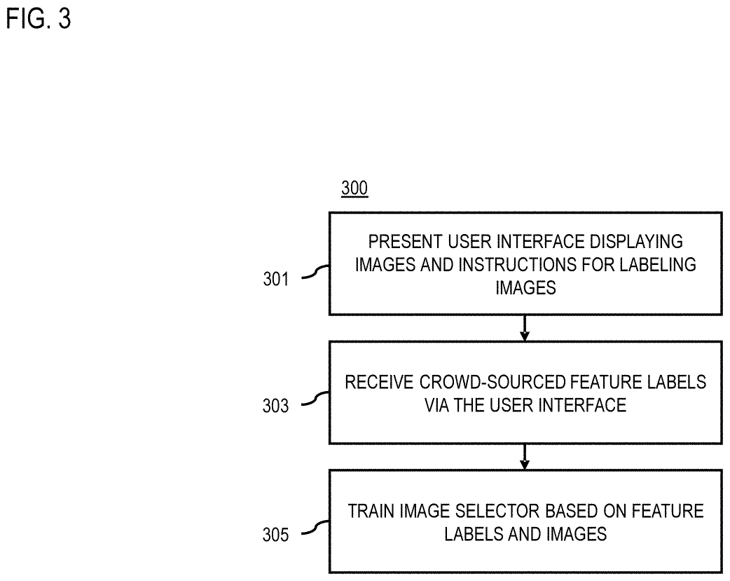

In one embodiment, as shown in FIG. 2, the mapping platform 103 includes one or more components for providing data-driven selection of machine learning observations, according to the various embodiments described herein. It is contemplated that the functions of these components may be combined or performed by other components of equivalent functionality. In this embodiment, the mapping platform 103 includes a crowd source module 201, training module 203, annotation module 205, and application module 207. The above presented modules and components of the mapping platform 103 can be implemented in hardware, firmware, software, or a combination thereof. Though depicted as a separate entity in FIG. 1, it is contemplated that the mapping platform 103 may be implemented as a module of any other component of the system 100 (e.g., a component of a services platform 111, services 113a-113n (also collectively referred to as services 113), vehicle 107, user equipment device (UE) 115, application 117 executing on the UE 115, etc.). In another embodiment, one or more of the modules 201-207 may be implemented as a cloud based service, local service, native application, or combination thereof. The functions of the mapping platform 103 and the modules 201-207 are discussed with respect to FIGS. 3-5 below.

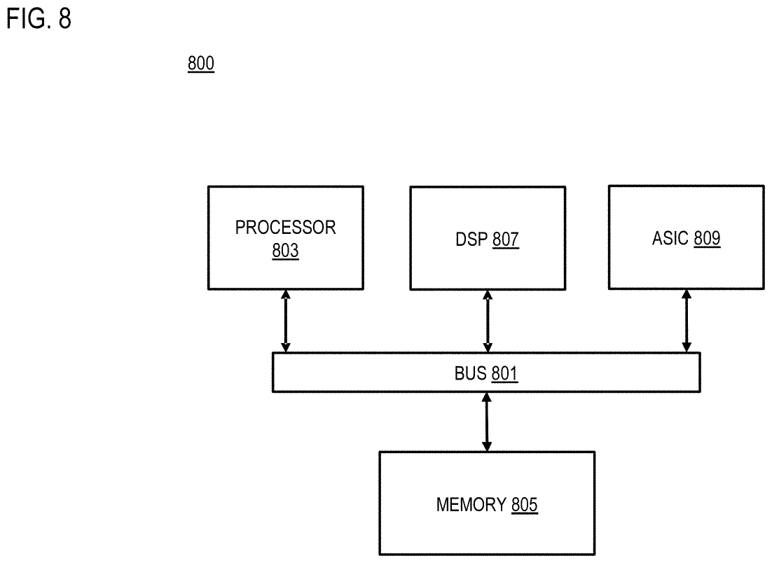

FIG. 3 is a flowchart of a process for providing data-driven selection of machine learning training observations, according to one embodiment. In various embodiments, the mapping platform 103 and/or any of the modules 201-207 of the mapping platform 103 may perform one or more portions of the process 300 and may be implemented in, for instance, a chip set including a processor and a memory as shown in FIG. 8. As such, the mapping platform 103 and/or the modules 201-207 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all of the illustrated steps.

As described above, various embodiments of the process 300 use a data driven, empirical approach to image selection utilizing, for instance, non-expert, crowd sourced human input. To initiate the process 300, in step 301, the crowd source module 201 presents or provides data for presenting a user interface displaying a plurality of training images and specifying a feature to label in the plurality of training images. By way of example, the data can identify what images from a candidate pool of images to present in the user interface as well as instructions for users to follow to label the feature or features in the displayed images. The instructions can specify an annotation task for the user to follow. In one embodiment, because this initial annotation or labeling task is directed to non-expert users who may not have domain specific knowledge or training in feature labeling, the instructions can be more limited than would traditionally be provided to expert human labelers. Limited, for instance, may refer to instructions with fewer steps or without steps that require specific feature labeling training to perform. For example, a limited instruction set may ask a user to visually identify and label a feature in the presented images but may not ask the user to determine precise positional data of the labeled feature (e.g., using a sophisticated instruction set and labeling tools used by expert labelers).

In one embodiment, the crowd source module 201 can select the feature included in the instruction set to non-expert users based on an image selection criterion. The image selection criterion can specify a maximum frequency at which the feature occurs within a pool of images. In other words, the crowd source module 201 can apply image selection criteria to determine features that occur infrequently such as less than a designated percentage (e.g., <10%) of the images. In this way, the feature can be relatively rare so that a more diverse set of features and corresponding images depicting those features can be selected for in the training data set and ultimately by the image selector 101 trained using the training data set.

In yet another embodiment, the crowd source module 201 can select a feature for users to label based on a visibility of the feature in a pool of images. Visibility refers to what degree a feature is photo-identifiable by a non-expert user when viewing an image. For example, the degree of photo-identifiability or visibility can be determined by determining whether a known feature is visually identified by greater than a designated percentage of users viewing test images of the feature; or any other equivalent process. In some embodiments, the crowd source module 201 can also instruct users to label contextual parameters that are identifiable in the images. For example, these contextual parameters can include but are not limited to weather (e.g., sunny, rainy, snowy, etc.), light level (e.g., day versus night), and/or the like.

After selecting the images, features, and accompanying instruction set, the annotation module 205 initiates a presentation of a labeling user interface with these images, features, and instructions to crowd-sourced or non-expert users. In response to the presentation of the user interface, in step 303, the annotation module 205 receives a set of feature labels for the plurality of training images via the user interface based on the crowd-sourced input data. The feature labels, for instance, represent the visible features, contextual features, etc. that the crowd-sourced non-expert users have annotated in the images.

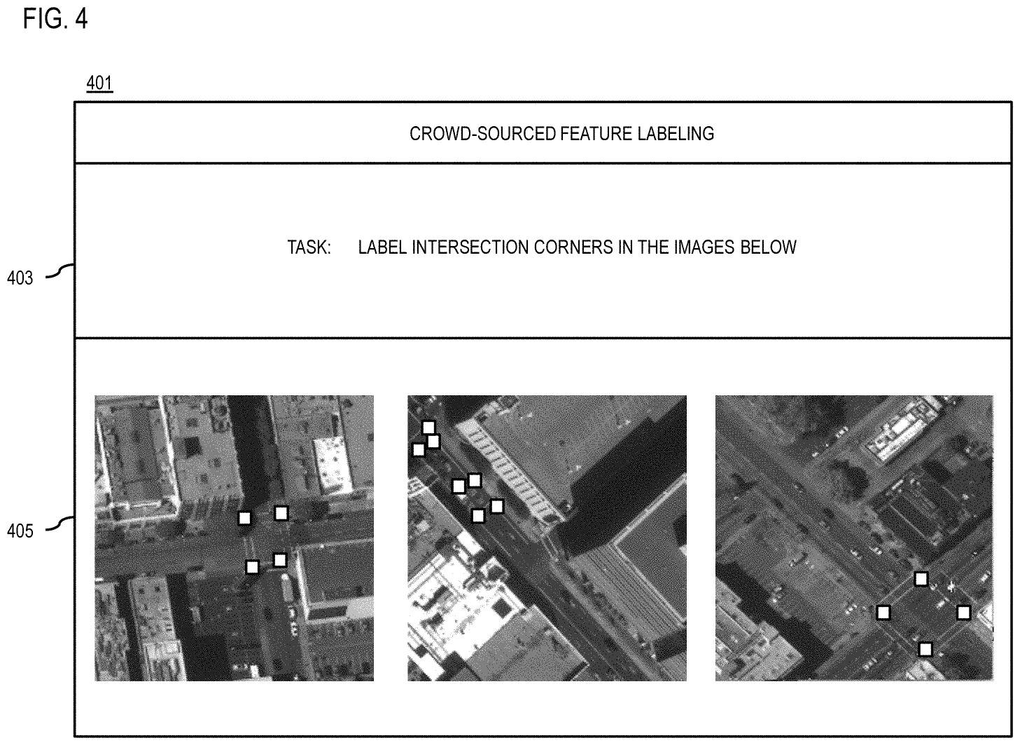

FIG. 4 is a diagram of a user interface for providing data-driven selection of machine learning training observations, according to one embodiment. In the example of FIG. 4, a crowd-sourced feature labeling user interface (UI) 401 is created by the crowd source module 201 according to the embodiments described above. The UI 401 includes an instruction set 403 tasking crowd-sourced users to “Label intersection corners in the images below” and presenting a set of images 405 that are to be labeled. Crowd-sourced users can interact with the UI 401 to place markers (e.g., depicted as white squares overlaid on the images 405) to indicate where the specified feature (e.g., intersection corner) is visible in each of the images 405. The marker data and associated feature comprise the feature labels specified by each crowd-sourced user via the UI 401. In one embodiment, the UI 401 or equivalent can be presented to large number of crowd-sourced non-expert users to collect feature labels at relatively low cost and with relatively low resource expenditures.

In general, the feature labels obtained from the crowd, with simplified instruction will not have positional quality. However, machine learning algorithms/models (e.g., of the image selector 101) can be trained using this low precision albeit high recall data and can then the trained image selector 101 can act as a great image selector or patch grabber in a big satellite image.

Accordingly, in one embodiment, in step 305, the training module 203 trains the machine learning based image selector 101 to select a plurality of images, a plurality of patches of a larger image (e.g. satellite or aerial image), or a combination thereof for labeling based on the set of feature labels and the plurality of training images. Training, for instance, refers to adapting parameters of the machine learning model or algorithm to process a candidate pool of images (e.g., a datastore of millions of ground-level images collected by a typical mapping service provider) to select which images should be prioritized for labeling (e.g., labeling by a limited number of expert labelers). For example, the mapping platform 103 can incorporate a supervised learning model (e.g., a logistic regression model, RandomForest model, and/or any equivalent model) to provide feature matching probabilities that are learned from the training data set. During training, the training module 203 feeds feature sets from the training data set into the machine learning model of the image selector 101 to compute a predicted matching feature using an initial set of model parameters.

The training module 203 then compares the predicted matching probability and the predicted feature to the ground truth data (e.g., the manually annotated feature labels) in the training data set for each observation (e.g., image) used for training. The training module 203 then computes an accuracy of the predictions for the initial set of model parameters. If the accuracy or level of performance does not meet a threshold or configured level, the training module 203 incrementally adjusts the model parameters until the model generates predictions at a desired or configured level of accuracy with respect to the crowd-sourced feature labels in the training data (e.g., the ground truth data). In other words, a “trained” feature prediction model is a classifier with model parameters adjusted to make accurate predictions with respect to the training data set. In one embodiment, the predictions made by the trained image selector 101 are a set of diverse observations or images.

By automatically selecting a set of diverse observations for human annotation, the system 100 enables the training of better models of other machine learning systems (e.g., feature detector 105) with more efficient use of labeling resources. For example, if the system 100 has resources available to annotate 100,000 images or observations, the system can spread those resources to annotating 1,000 observations of 100 different types of features, as opposed to spending the resources to annotate more observations of a less diverse set of feature types if sampling of observations is determined by random.

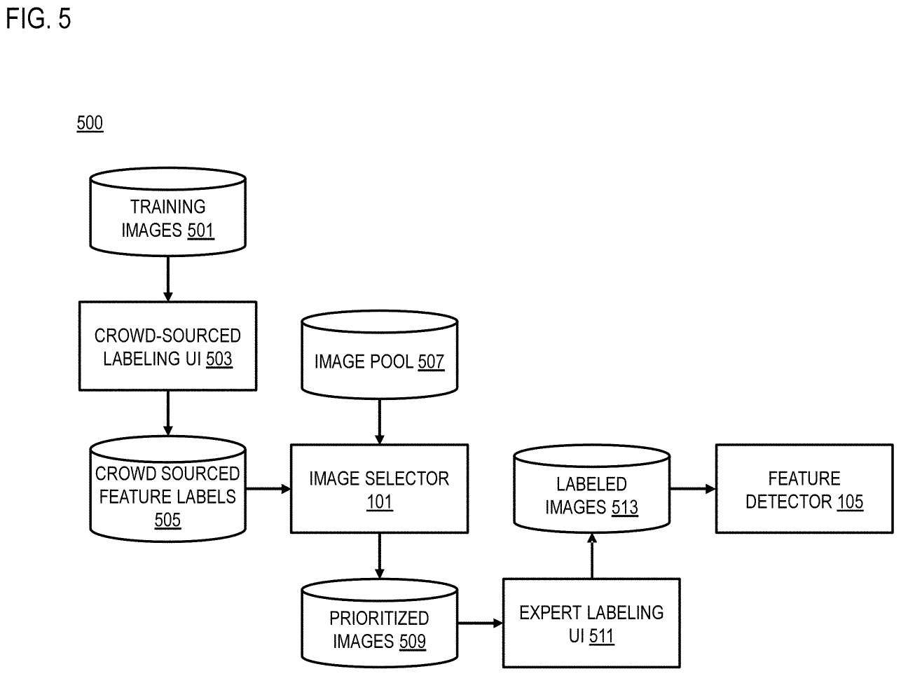

FIG. 5 is a diagram illustrating an example process flow 500 that incorporates the process 300 for providing data-driven selection of machine learning training observations, according to one embodiment. As shown, the process flow 500 includes obtaining a set of training images 501 that be labeled by crowd-sourced users. The mapping platform 103 then creates a crowd-sourced labeling UI 503 that presents the images 501 along with a simplified annotation task to completed by the crowd-sourced users. For example, a sample annotation task could ask users to annotate specific feature types on a road surface, which can occur infrequently within a pool of images (e.g., occurring in <10% of images). The crowd-sourced users can interact with the UI 503 to perform the annotation task to generate crowd-sourced feature labels 505.

The crowd-sourced feature labels 505 are then used by the mapping platform 103 to train a machine learning model/algorithm of the machine learning based image selector 101 to select a diverse set of images to prioritize for annotation by expert labelers. The trained image selector 101 can be used to process an image pool 507 or equivalent datastore of unlabeled images to generate a set 509 of images selected from the image pool 507 that are to be prioritized for annotation.

The mapping platform 103 can then present the plurality of images selected by the image selector 101 (e.g., the prioritized images 509) in another user interface (e.g., an expert labeling UI 511) to expert labelers (e.g., human labelers with domain specific knowledge or training related to feature labeling) to generate a set of labeled prioritized images 513. For example, a manually marked feature that is an object (e.g., lane markings, road signs, etc.), for instance, can be a polygon or polyline representation of the feature that the expert labeler has visually detected in the image. In one embodiment, the polygon, polyline, and/or other feature indicator can outline or indicate the pixels or areas of the image that the labeler designates as depicting the labeled feature. Achieving consistent and high quality labeling outlines often requires domain specific knowledge or training. The labeled prioritized images 513 can be used to train a machine learning model or algorithm of a machine learning based feature detector 105 or other classifier to detect or classify features labeled in the prioritized images 513. It is noted that although the various embodiments and examples described herein are discussed with respect to images as example of training observations for machine learning, it is contemplated that the embodiments are applicable to any type of training observation (e.g., sensor data, text, audio, etc.).

In one embodiment, machine learning using, e.g., feature prediction models trained according to the embodiments described herein, enable a range of services and functions including for applications such as autonomous driving. The application module 207 of the mapping platform 103 can interface or interact with any of these services to provide data-driven selection of machine learning observations. For example, the application module 207 can support machine learning used in autonomous driving applications. With respect to autonomous driving, computer vision and computing power have enabled real-time mapping and sensing of a vehicle's environment. Such an understanding of the environment enables autonomous, semi-autonomous, or highly assisted driving in a vehicle (e.g., a vehicle 107) in at least two distinct ways.

First, real-time sensing of the environment provides information about potential obstacles, the behavior of others on the road, and safe, drivable areas. An understanding of where other cars are and what they might do is critical for a vehicle 107 to safely plan a route. Moreover, vehicles 107 generally must avoid both static (lamp posts, e.g.) and dynamic (cats, deer, e.g.) obstacles, and these obstacles may change or appear in real-time. More fundamentally, vehicles 107 can use a semantic understanding of what areas around them are navigable and safe for driving. Even in a situation where the world is completely mapped in high resolution, exceptions will occur in which a vehicle 107 might need to drive off the road to avoid a collision, or where a road's geometry or other map attributes like direction of travel have changed. In this case, detailed mapping may be unavailable, and the vehicle 107 has to navigate using real-time sensing of road features or obstacles using a feature detector 105 facilitated, for instance, by machine learning processes and models.

A second application of vision techniques in autonomous driving is localization of the vehicle 107 with respect to a map of reference landmarks. Understanding one's location on a map enables planning of a route, both on fine and coarse scales. On a coarse scale, navigation maps allow vehicles 107 to know what roads to use to reach a particular destination. However, on a finer scale, maps allow vehicles 107 to know what lanes to be in and when to make lane changes. Knowing this information is important for planning an efficient and safe route, for in complicated driving situations maneuvers need to be executed in a timely fashion, and sometimes before they are visually obvious. In addition, localization with respect to a map enables the incorporation of other real-time information into route planning. Such information could include traffic, areas with unsafe driving conditions (ice, fog, potholes, e.g.), and temporary road changes like construction.

With respect to lane localization and also generally with respect to autonomous driving, high accuracy and real-time localization of vehicles 107 are needed. Traditionally, most vehicle navigation system have accomplished this localization using GPS, which generally provides a real-time location with a 95% confidence interval of 7.8 meters. However, in complicated urban environments, reflection of GPS signals can further increase this error, such that one's location may be off by as much as 30 meters. Given that the width of many lanes is 3-4 meters, this accuracy is not sufficient to properly localize a vehicle 107 (e.g., an autonomous vehicle) so that it can make safe route planning decisions. Other sensors, such as inertial measurement units (IMGs) can increase the accuracy of localization by taking into account vehicle movement, but these sensors tend to drift and still do not provide sufficient accuracy for localization.

In general, a localization accuracy of around 10 cm is needed for safe driving in many areas. One way to achieve this level of accuracy is to use visual odometry, in which features are detected from imagery using feature prediction models (i.e., a machine learning classifier). These features can then be matched to a database of features to determine one's location. By way of example, traditional feature-based localization that both detect features and localize against them generally rely on low-level features. However, low-level features typically used in these algorithms (e.g., Scale-Invariant Feature Transform (SIFT) or Oriented FAST and rotated BRIEF (ORB)) tend to be brittle and not persist in different environmental and lighting conditions. As a result, they often cannot be used to localize a vehicle on different days in different weather conditions. Aside from reproducibility, the ability to detect and store higher level features of different types (e.g.., lane features such as lane markings, lane lines, etc.) can provide better and more accurate localization.

Returning to FIG. 1, as shown, the system 100 includes the mapping platform 103 for providing data-driven selection of machine learning observations according the various embodiments described herein. In some use cases, the system 100 can include a feature detector 105 (e.g., a computer vision system) configured to use machine learning to detect objects or features depicted in images. For example, with respect to autonomous, navigation, mapping, and/or other similar applications, the feature detector 105 can detect road features (e.g., lane lines, signs, poles, etc.) in an input image and generate associated prediction confidence values, according to the various embodiments described herein. In one embodiment, the mapping platform 103 includes a neural network or other machine learning/parallel processing system to make predictions from machine learning models. For example, when the observations are images used for visual odometry, the features of interest can include lane lines in image data to support localization of, e.g., a vehicle 107 within the sensed environment. In one embodiment, the neural network of the mapping platform 103 (e.g., the image selector 101 and/or feature detector 105) is a traditional convolutional neural network which consists of multiple layers of collections of one or more neurons (e.g., processing nodes of the neural network) which are configured to process a portion of an input image. In one embodiment, the receptive fields of these collections of neurons (e.g., a receptive layer) can be configured to correspond to the area of an input image delineated by a respective a grid cell generated as described above.

In one embodiment, the mapping platform 103 and/or the feature detector 105 also have connectivity or access to a geographic database 109 which stores representations of mapped geographic features to facilitate visual odometry to increase localization accuracy. The geographic database 109 can also store data related to providing data-drive selection of machine learning training observations.

In one embodiment, the mapping platform 103 have connectivity over a communication network 119 to the services platform 111 that provides one or more services 113. By way of example, the services 113 may be third party services and include mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 113 uses the output of the mapping platform 103 and/or of the feature detector 105 (e.g., detected lane features) to localize the vehicle 107 or a user equipment 115 (e.g., a portable navigation device, smartphone, portable computer, tablet, etc.) to provide services 113 such as navigation, mapping, other location-based services, etc.

In one embodiment, the mapping platform 103, image selector 101, and/or feature detector 105 may be a platform with multiple interconnected components. The mapping platform 103 image selector 101, and/or feature detector 105 may include multiple servers, intelligent networking devices, computing devices, components and corresponding software for providing parametric representations of lane lines. In addition, it is noted that the mapping platform 103 image selector 101, and/or feature detector 105 may be a separate entity of the system 100, a part of the one or more services 113, a part of the services platform 111, or included within the UE 115 and/or vehicle 107.

In one embodiment, content providers 121a-121m (collectively referred to as content providers 121) may provide content or data (e.g., including geographic data, parametric representations of mapped features, etc.) to the geographic database 109, the mapping platform 103, the image selector 101, the feature detector 105, the services platform 111, the services 113, the UE 115, the vehicle 107, and/or an application 117 executing on the UE 115. The content provided may be any type of content, such as map content, textual content, audio content, video content, image content, etc. In one embodiment, the content providers 121 may provide content that may aid in the providing data-driven selection of training observations. In one embodiment, the content providers 121 may also store content associated with the geographic database 109, mapping platform 103, image selector 101, feature detector 105, services platform 111, services 113, UE 115, and/or vehicle 107. In another embodiment, the content providers 121 may manage access to a central repository of data, and offer a consistent, standard interface to data, such as a repository of the geographic database 109.

In one embodiment, the UE 115 and/or vehicle 107 may execute a software application 117 to collect, encode, and/or decode feature data detected in image data to select training observations for machine learning models according the embodiments described herein. By way of example, the application 117 may also be any type of application that is executable on the UE 115 and/or vehicle 107, such as autonomous driving applications, mapping applications, location-based service applications, navigation applications, content provisioning services, camera/imaging application, media player applications, social networking applications, calendar applications, and the like. In one embodiment, the application 117 may act as a client for the mapping platform 103 and/or feature detector 105 and perform one or more functions associated with selecting training observations for machine learning models alone or in combination with the mapping platform 103.

By way of example, the UE 115 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 115 can support any type of interface to the user (such as “wearable” circuitry, etc.). In one embodiment, the UE 115 may be associated with the vehicle 107 or be a component part of the vehicle 107.

In one embodiment, the UE 115 and/or vehicle 107 are configured with various sensors for generating or collecting environmental image data (e.g., for processing by the mapping platform 103, image selector 101, and/or feature detector 105), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 115 and/or vehicle 107 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 115 and/or vehicle 107 may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 115 and/or vehicle 107 may include GPS or other satellite-based receivers to obtain geographic coordinates from satellites 123 for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 119 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 103, image selector 101, feature detector 105, services platform 111, services 113, UE 115, vehicle 107, and/or content providers 121 communicate with each other and other components of the system 100 using well known, new or still developing protocols. In this context, a protocol includes a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

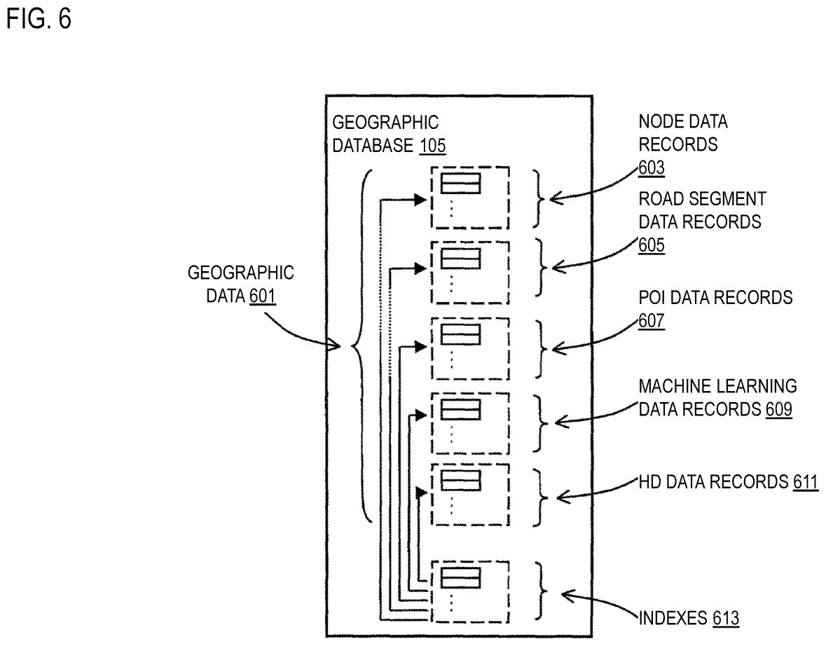

FIG. 6 is a diagram of a geographic database, according to one embodiment. In one embodiment, the geographic database 109 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 109 include high resolution or high definition (HD) mapping data that provide centimeter-level or better accuracy of map features. For example, the geographic database 109 can be based on Light Detection and Ranging (LiDAR) or equivalent technology to collect billions of 3D points and model road surfaces and other map features down to the number lanes and their widths. In one embodiment, the HD mapping data (e.g., HD data records 611) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 109 includes node data records 603, road segment or link data records 605, POI data records 607, machine learning data records 609, HD mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 109. In one embodiment, the indexes 613 may be used to quickly locate data without having to search every row in the geographic database 109 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 607. The geographic database 109 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 109 can also include machine learning data records 609 for storing selected training observation, feature labels (e.g., crowd-sourced and/or expert labels), training data, prediction models, annotated observations, computed featured distributions, sampling probabilities, and/or any other data generated or used by the system 100 according to the various embodiments described herein. By way of example, the machine learning data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the HD mapping data records 611 model road surfaces and other map features to centimeter-level or better accuracy. The HD mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 611 are divided into spatial partitions of varying sizes to provide HD mapping data to vehicles 107 and other end user devices with near real-time speed without overloading the available resources of the vehicles 107 and/or devices (e.g., computational, memory, bandwidth, etc. resources).

In one embodiment, the HD mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 611.

In one embodiment, the HD mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 109 can be maintained by the content provider 121 in association with the services platform 111 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle (e.g., vehicle 107 and/or UE 115) along roads throughout the geographic region to observe features and/or record information about them, for example. Also, remote sensing, such as aerial or satellite photography, can be used.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 107 or UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for selecting training observations for machine learning models may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

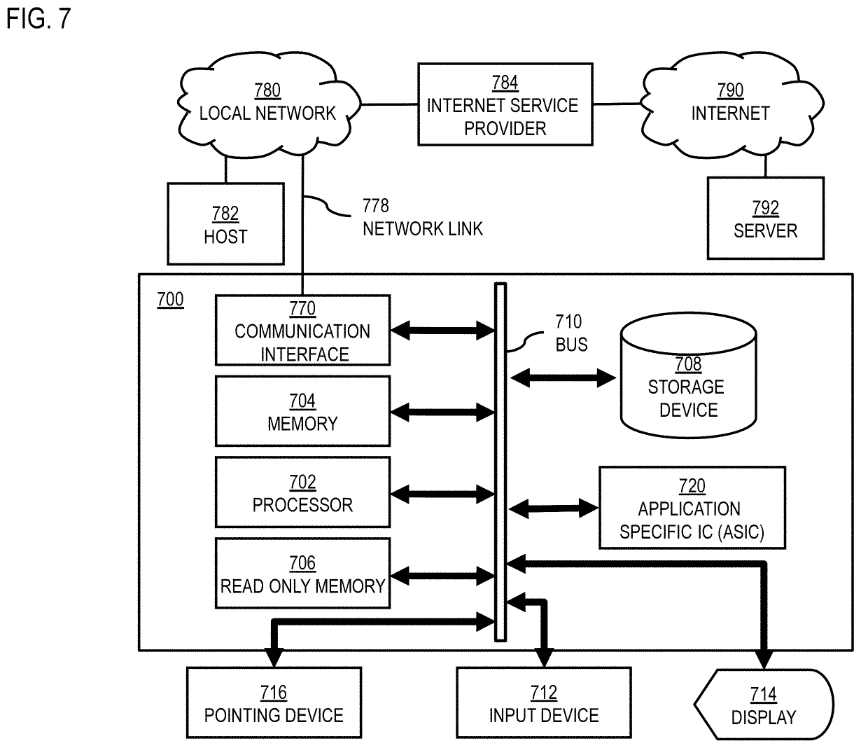

FIG. 7 illustrates a computer system 700 upon which an embodiment may be implemented. Computer system 700 is programmed (e.g., via computer program code or instructions) to select training observations for machine learning models as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to selecting training observations for machine learning models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for selecting training observations for machine learning models. Dynamic memory allows information stored therein to be changed by the computer system 700. RANI allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for selecting training observations for machine learning models, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 119 for selecting training observations for machine learning models.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to select training observations for machine learning models as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RANI, magnetic disk, writable optical disk, etc.) and static memory (e.g., ROM, CD-ROM, etc.) for storing executable instructions that when executed perform the inventive steps described herein to select training observations for machine learning models. The memory 805 also stores the data associated with or generated by the execution of the inventive steps.

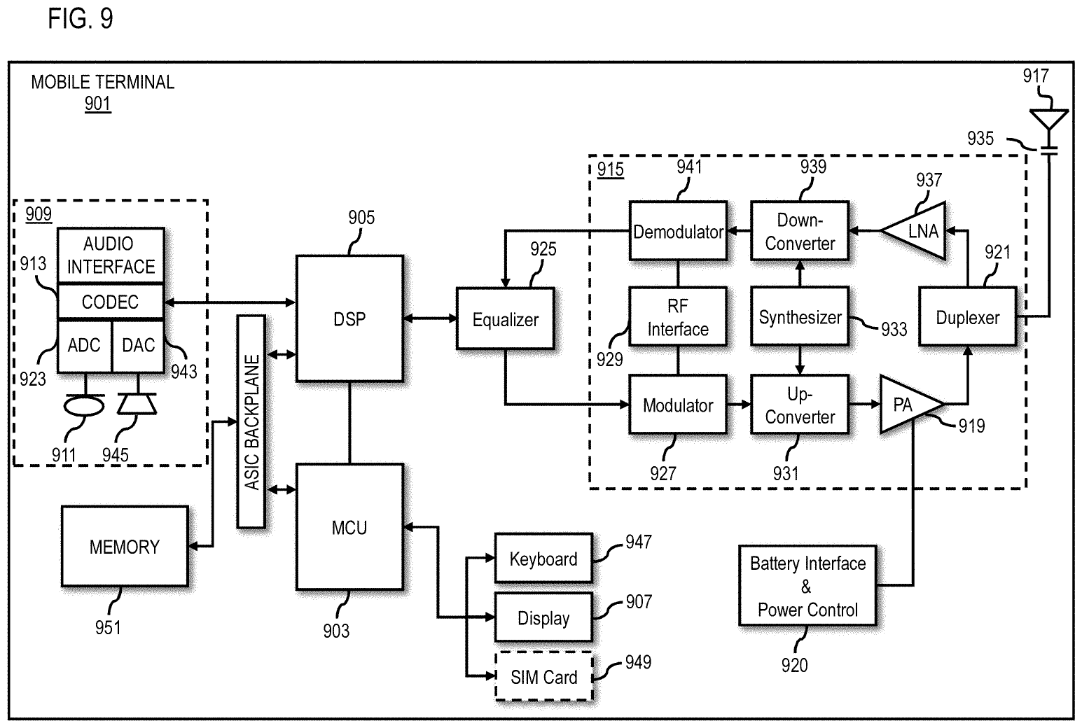

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to select training observations for machine learning models. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RANI memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
providing data for presenting a user interface displaying a plurality of training images and specifying a feature to label in the plurality of training images, wherein the feature is selected based on an image selection criterion;
receiving a set of feature labels for the plurality of training images via the user interface based on crowd-sourced input data; and
training a machine learning based image selector to select a plurality of images, a plurality of patches of a larger image, or a combination thereof for labeling based on the set of feature labels and the plurality of training images.

2. The method of claim 1, wherein the image selection criterion specifies a maximum frequency at which the feature occurs within a pool of images.

3. The method of claim 1, wherein the feature is selected based on a visibility of the feature in a pool of images.

4. The method of claim 1, wherein the crowd-sourced input data is received via the user interface from a plurality of users who are non-experts with respect to feature labeling.

5. The method of claim 1, further comprising:
presenting the plurality of images selected by the machine learning based image selector in another user interface for labeling of the plurality of images.

6. The method of claim 5, wherein the plurality of images is used to train a machine learning model to identify one or more features in image data after the labeling of the plurality of images.

7. The method of claim 5, wherein the another user interface is presented to a plurality of users who are experts with respect to feature labeling.

8. An apparatus comprising:
at least one processor; and
at least one memory including computer program code for one or more programs,
the at least one memory and the computer program code configured to, with the at least one processor, cause the apparatus to perform at least the following,
provide data for presenting a user interface displaying a plurality of training images and specifying a feature to label in the plurality of training images, wherein the feature is selected based on an image selection criterion;
receive a set of feature labels for the plurality of training images via the user interface based on crowd-sourced input data; and
train a machine learning based image selector to select a plurality of images, a plurality of patches of a larger image, or a combination thereof for labeling based on the set of feature labels and the plurality of training images.

9. The apparatus of claim 8, wherein the image selection criterion specifies a maximum frequency at which the feature occurs within a pool of images.

10. The apparatus of claim 8, wherein the feature is selected based on a visibility of the feature in a pool of images.

11. The apparatus of claim 8, wherein the crowd-sourced input data is received via the user interface from a plurality of users who are non-experts with respect to feature labeling.

12. The apparatus of claim 8, wherein the apparatus is further caused to:
present the plurality of images selected by the machine learning based image selector in another user interface for labeling of the plurality of images.

13. The apparatus of claim 12, wherein the plurality of images is used to train a machine learning model to identify one or more features in image data after the labeling of the plurality of images.

14. The apparatus of claim 12, wherein the another user interface is presented to a plurality of users who are experts with respect to feature labeling.

15. A non-transitory computer-readable storage medium for sampling from a candidate pool of observations to create a training data set for a machine learning model, carrying one or more sequences of one or more instructions which, when executed by one or more processors, cause an apparatus to perform:
providing data for presenting a user interface displaying a plurality of training images and specifying a feature to label in the plurality of training images, wherein the feature is selected based on an image selection criterion;
receiving a set of feature labels for the plurality of training images via the user interface based on crowd-sourced input data; and
training a machine learning based image selector to select a plurality of images, a plurality of patches of a larger image, or a combination thereof for labeling based on the set of feature labels and the plurality of training images.

16. The non-transitory computer-readable storage medium of claim 15, wherein the image selection criterion specifies a maximum frequency at which the feature occurs within a pool of images.

17. The non-transitory computer-readable storage medium of claim 15, wherein the feature is selected based on a visibility of the feature in a pool of images.

18. The non-transitory computer-readable storage medium of claim 15, wherein the crowd-sourced input data is received via the user interface from a plurality of users who are non-experts with respect to feature labeling.

19. The non-transitory computer-readable storage medium of claim 15, wherein the apparatus is caused to further perform:
presenting the plurality of images selected by the machine learning based image selector in another user interface for labeling of the plurality of images.

20. The non-transitory computer-readable storage medium of claim 19, wherein the plurality of images is used to train a machine learning model to identify one or more features in image data after the labeling of the plurality of images.
